(19) United States
(12) Patent Application Publication
(10) Pub. No.: US 2006/0222186 A1
(43) Pub. Date: Oct. 5, 2006

(54) Multi-channel audio switch

(76) Inventors: Robert F. Paige, Cedar City, UT (US); Tom Schmidt, Bloomington, MN (US)

Correspondence Address: HOGAN & HARTSON LLP, ONE TABOR CENTER, SUITE 1500, 1200 SEVENTEENTH ST, DENVER, CO, 80202, US

(21) Appl. No.: 11/099,101

(22) Filed: Apr. 5, 2005

(51) Int. Cl. H02B 1/00; H04B 3/00

(52) U.S. Cl. 381/81; 381/123

(57) ABSTRACT

An audio switch for theatre environments comprising a plurality of analog audio inputs such as 5.1 or 6.1 multi-channel analog audio inputs. An audio output is provided as well as means for selectively coupling any one of the audio inputs to the audio output. The audio switch includes a control interface configured to couple to an external control system. The means for selectively coupling operates in response to control signals received over the control interface

### BACKGROUND OF THE INVENTION

1. Field of the Invention

The present invention relates, in general, to cinema sound systems, and, more particularly, to systems and methods for intelligently switching multiple analog audio sources into cinema audio equipment.

2. Relevant Background

Cinema audio systems comprise multiple components that process audio signals, amplify those signals, and drive the amplified signals to speakers in the auditorium system. There are an increasing variety of audio formats and equipment for presenting audio content. A typical theatre auditorium has an installed sound system that may include a cinema audio processor for decoding and filtering various encoded signals, as well as amplifiers, speaker systems and the like for presenting the audio content. Multi-channel analog audio systems such 5.1 (six channel) and 6.1 (seven channel) and 7.1 (eight channel) are becoming increasingly popular in commercial as well as home theatre environments. As a result, a wide variety of audio sources including computers, cable boxes, DVD players, video tape players, audio and video receivers, and the like can produce high quality multi-channel analog signals.

Unfortunately, commercial cinema audio processing components are relatively inflexible in handling these widely available multi-channel analog audio sources. Many cinema sound systems are specifically designed to receive audio signals from a single source such as a projector, but are not equipped to receive audio information from alternative sources such as computers, DVD players, CD players, live microphones and the like. While producers of cinema audio equipment may one day produce new equipment with more inputs, replacing existing back-end processing systems such as analog cinema processors and/or amplifiers will likely be expensive.

Conventional sound-on-film systems for 35 mm theatre-class projection systems use optical encoding. The optically encoded signal is read from the film and processed by a digital film sound processor such as a DA20 digital adapter produced by Dolby Laboratories, Inc to generate a multi-channel output (e.g., a 5.1 audio signal). The 5.1 audio signal may be further processed by an analog cinema processor such as a CP45 or CP650 produced by Dolby Laboratories to process proprietary sound formats. The analog cinema processor may be replaced or augmented with audio amplifiers that drive auditorium speakers.

An alternative digital sound system is SDDS (Sony Dynamic Digital Sound) provided by Sony Corporation. SSDS is a digital film sound format comprised of a soundtrack, optically printed on both edges of 35 mm film, and playback hardware that includes a reader and decoder. The decoder outputs a multi-channel analog audio to the downstream amplification systems and speakers.

Another alternative audio system is provided by DTS of Agoura Hills, Calif. in which the audio soundtrack is not contained on the film itself, but on separate media sources such as compact disk or CD-ROM disks. A playback unit synchronizes the audio playback with a film and generates a multi-channel output (e.g., 5.1 audio) that can be subsequently processed in a manner similar to the sound-on-film systems described above.

One solution to this problem has been to install a media adapter such as a DMA-8 media adapter produced by Dolby Laboratories, Inc. This equipment allows selection of various digital input sources (PCM or Dolby® formats only) to drive a multi-channel analog output to a sound system. However, this type of switching equipment is relatively expensive, and provides more features than may be necessary in many applications. Unlike analog input signals that are inherently format-independent, digital input switching equipment will only support specific digital input formats. Commercially available media adapters include a single six-channel audio input, usually intended to handle the 5.1 audio signal from a sound processor that is decoding the optically encoded audio from a film projector. Hence, these systems cannot be used to intelligently switch a variety of 5.1 (or 6.1) audio sources to the downstream components.

Accordingly, a need exists for a simple yet robust and functional system and method for interfacing cinema sound systems and audio processors with alternative audio sources.

### SUMMARY OF THE INVENTION

Briefly stated, the present invention involves an audio switch for theatre environments comprising a plurality of analog audio inputs such as 5.1 or 6.1 multi-channel analog audio inputs. An audio output is provided as well as means for selectively coupling any one of the audio inputs to the audio output. In another aspect, the present invention involves a cinema audio system having a projector (e.g., a film projector operable to display film-based media, a digital cinema projector operable to display digitized media, and/or other projector) in a theatre auditorium and at least one other device producing a multi-channel analog audio signal. A sound processor generates a multi-channel analog audio signal synchronized with the projected media. An audio switch has a first of a plurality of analog inputs coupled to the sound processor to receive the multi-channel analog audio signal from the sound processor. The audio switch has a second analog input coupled to the at least one other device. The switch includes components for selectively coupling any one of the plurality of the switch's audio inputs to the audio output.

### BRIEF DESCRIPTION OF THE DRAWINGS

FIG. 1 illustrates a theatre environment having multiple audio sources and an intelligent audio switch in accordance with an embodiment of the present invention;

FIG. 2 illustrates another theatre environment having multiple audio sources and an intelligent audio switch in accordance with an embodiment of the present invention; and

FIG. 3 shows, in block-diagram form, an intelligent audio switch in accordance with an embodiment of the present invention.

### DETAILED DESCRIPTION OF THE PREFERRED EMBODIMENTS

The present invention is illustrated and described in terms of a commercial theatre environment in which multiple audio sources are intelligently switched in accordance with the present invention. However, the present invention is readily applicable to a wide variety of applications where intelligent switching of high-quality multi-channel analog audio sources is desired.

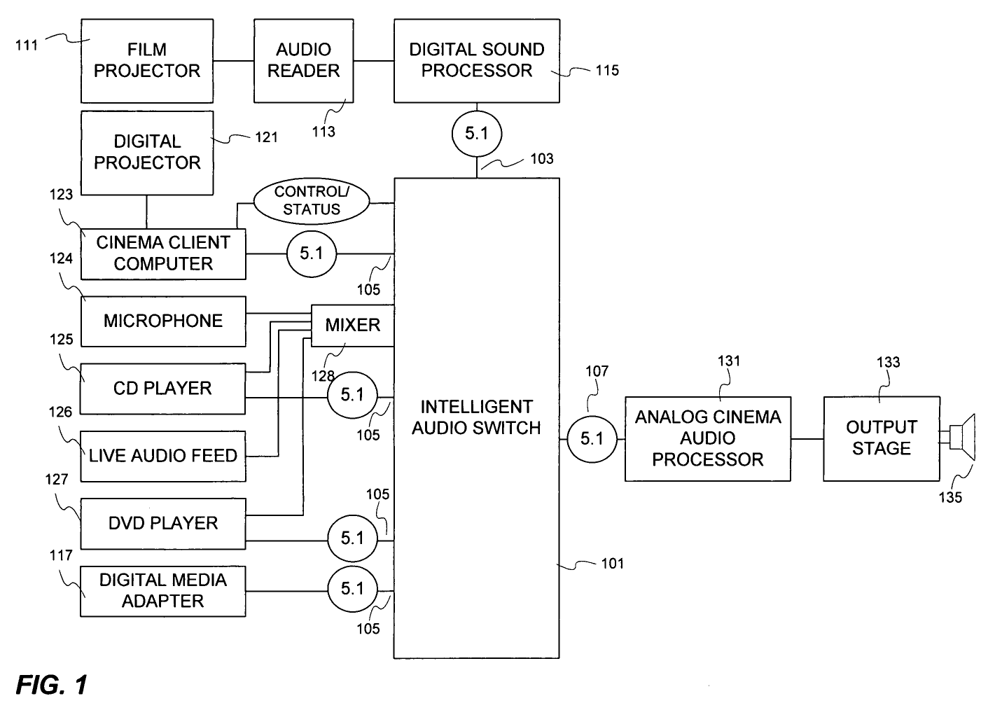

FIG. 1 illustrates a theatre environment having multiple audio sources and an intelligent audio switch in accordance with an embodiment of the present invention. In the implementation of FIG. 1, a single film based projector 111 serves as a primary source of audio as would be the case in number of commercial theatres in which presentation of film-based entertainment remains a primary business purpose. Intelligent audio switch 101 comprises a plurality of multi-channel analog audio inputs 103 and 105. In an embodiment of the present invention, one audio input 103 is designated as a primary multi-channel analog audio input while any number of secondary multi-channel analog audio inputs 105 may be provided. The primary audio input 103 is specially configured within intelligent audio switch 101 to be in an on state (i.e., connected to audio output 107) even when there is a power interruption or other malfunction within intelligent audio switch 101.

In a particular example, primary input 103 is coupled to a multi-channel analog audio signal from a primary presentation device such as a film projector. FIG. 1 illustrates an implementation in which a film projector 111 serves as the source of the audio signal to primary input 103. Film projector 111 may be a single film projector or multiple film projectors. Each film projector 111 is equipped with an audio reader 113 that reads an audio signal encoded on film-based media as it is displayed by film projector 111.

Audio reader 113 is coupled to a soundtrack reader integrated with projector 111 or provided as a “penthouse” style unit that attaches to projector 111. Reader 113 produces a digital or analog signal, depending on the particular application. In some applications the decoded signal from audio reader 113 can be used “as-is” if it is output in a suitable analog format. In other applications, however, the output signal from reader 113 comprises digital data that must be further processed. The output signal from reader 113 may include information, such as surround sound information, that can be used to provide enhanced audio performance. In many cases this additional information may use a proprietary format communicate the enhanced information such as Dolby Digital, Dolby Pro Logic II, Dolby Digital EX, THX EX and Dolby SR formats defined by Dolby Laboratories, Inc. and/or DTS, DTS Neo:6, DTS ES, and DTS 96/24 formats defined Digital Theatre Systems, as well as other formats that are or may become available. In these applications a digital sound processor 115 may be used to process the audio signal from reader 113 to perform such actions as decoding the digital signal.

Digital sound processor 115, sometimes called a digital adapter, comprises necessary electronics to drive the reader 113 and decode the audio signal from reader 113 to produce a multi-channel analog audio signal that is coupled either directly to primary multi-channel analog audio input port 103 of intelligent audio switch 101, or to a digital media adapter 117 which is configured to pass through the multi-channel analog audio signal to input port 103. Digital sound processor 115 may be implemented by, for example, a DA-20 sound processor from Dolby Laboratories or a DTS-6D digital playback system from DTS.

Digital media adapter 117 is essentially a switch that allows a selection between either a single multi-channel analog audio input or any of a number of pulse width modulated (PWM) digital audio signals. Digital media adapter 117 may be implemented, for example, by a Dolby® Model DMA™8 Digital Media Adapter ™ offered by Dolby Laboratories that allow the connection of a variety of digital media sources. Although FIG. 1 shows alternative audio inputs such as a cinema client computer 123, microphone 124, CD player 125, live audio feed 126 and DVD player 127 coupled to provide multi-channel analog audio inputs, some of these device may be able to generate a digital audio signal that coupled in. to digital media adapter 117.

However, digital media adapter 117 has but a single multi-channel analog audio input which is configured as a pass-through input. This means that unless an alternative audio source has a compatible digital output it cannot be switched by digital media adapter 117. The present invention provides a system for using these various sources in situations where a digital signal is not available form the source, when using the digital output from an alternative audio source might compromise the audio presentation, when the control features of a digital media adapter 117 are not flexible enough to meet the demands of a particular application, or when a digital media adapter is either not available or can be eliminated from the system.

Intelligent audio switch 101 in accordance with the present invention provides a plurality of multi-channel analog audio inputs 103/105 as well as control logic necessary to allow a multi-channel input to be selectively coupled to a multi-channel analog audio output 107. Each of audio inputs 103/105 supports a multi-channel analog audio signal such as 5.1, 6.1 and/or 7.1 or the like. It is contemplated that as audio engineering progresses other multi-channel formats will become available and that the present invention is readily adapted for such progress. The multi-channel analog audio signals on inputs 103/105 are typically analog signals, although hybrid systems with combinations of analog and digital signals are contemplated.

In the implementation of FIG. 1, each input 105 is coupled to a multi-channel analog audio source such as cinema client computer 123, microphone 124, CD player 125, live audio feed 126 and DVD player 127. In some implementations intelligent audio switch 111 is provided with a mixer input 128 that can be used for any audio source, but is particularly useful for audio sources such as microphone 124. Mixer 128 allows one or more channels of audio input to be mixed into a single channel.

Intelligent audio switch 101 may be controlled directly by control devices (e.g., switches, buttons and the like) integrated with the audio switch 101, or may be controlled by control signals from a cinema client 123. Cinema client 123 can be implemented by a computer or workstation that implements programs for coordinating the various devices that present information in an auditorium or group of auditoriums. Cinema client 123 may also implement control connections (not shown) to various other devices such as lighting systems, cinema automation systems, projectors 111/121, and other systems to control multiple aspects of an event presentation.

In the particular implantation shown in FIG. 1, cinema audio client 123 is coupled to a digital projector 121 and displays video content that is alternative to that provided by film projector 111. Cinema audio client may provide a pre-show before a film-based presentation, for example, or may be used to present content from any type of stored digital media file or from a live, delayed, or stored video stream. Cinema audio client also provide a multi-channel analog audio signal to intelligent audio switch 101 that is synchronized with the video content being played.

Alternatively or in addition, intelligent audio switch 101 may be controlled by a remote control such as a manually operated handheld remote control that is coupled by wires or wirelessly to intelligent audio switch 101. Such a configuration may be used instead of the programmatic control provided by an external control mechanism such as client 123, or may be used to override programmatic control as needed. For example, live events such as conferences, seminars, and the like may be sufficiently unique that writing a program to control the event activities is not efficient. In such a case a manually operated remote control is particularly useful for selecting amongst the variety of audio sources.

In operation, intelligent audio switch 101 receives control information and selects a multi-channel input 103/105 to be coupled to multi-channel output 107. In some applications multi-channel analog audio output 107 is coupled to an analog cinema audio processor 131 that provides additional signal processing, if necessary. Depending on the configuration it is possible that all necessary processing, such as decoding of surround sound information and the like, has been performed by upstream components. Output stage 133 is coupled to a multi-channel analog audio signal either directly from intelligent audio switch 101 or through cinema processor 131. Output stage 133 comprises devices such as amplifiers that drive auditorium speakers 135.

Intelligent audio switch 101 is preferably configured such that primary input 103 is active when there is an error, power failure, or other interruption in normal operation of intelligent audio switch 101. In a conventional commercial theatre, for example, it may be desired that the audio associated with a film-based presentation take precedence over other audio sources to avoid circumstances in which a film presentation is interrupted unnecessarily. This functionality can be implemented by, for example, using a normally on type relay to switch primary input 103 while using normally off relays, or semiconductor switches to implement inputs 105.

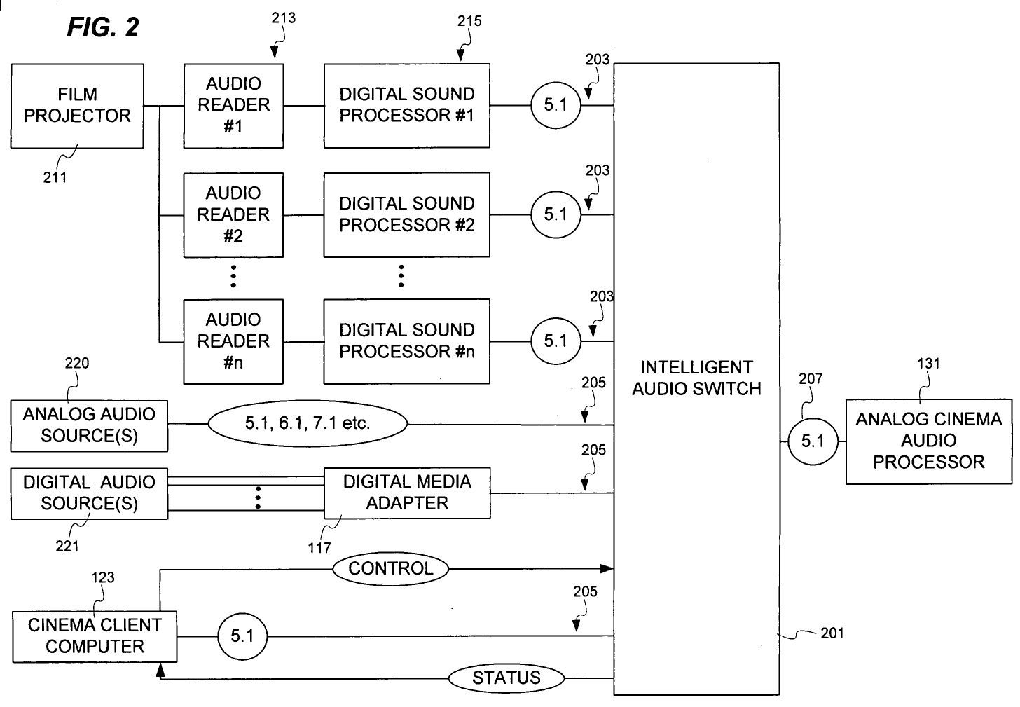

FIG. 2 illustrates another theatre environment having multiple “primary” audio sources and an intelligent audio switch 201 in accordance with an embodiment of the present invention. In the environment illustrated in FIG. 2 an auditorium supports a plurality audio encoding formats which increases the variety of film-based entertainment that can be presented. In the implementation of FIG. 2, a one or more film based projectors 211 serve(s) as a primary source for presenting film-based media, however, unlike the implementation of FIG. 1 the environment of FIG. 2 supports a variety of audio encoding formats including, for example, Dolby® and DTS® audio formats. Each format may require a separate reader 213 as indicated by readers 213 labeled “AUDIO READER #1, AUDIO READER #2 . . . AUDIO READER #3 in FIG. 2. It is also possible that a single reader 213 may be configured to read multiple types of encoded audio information in which case multiple readers 213 may not be required.

Each audio reader 213 is coupled to a soundtrack reader integrated with projector 211 or provided as a “penthouse” style unit that attaches to projector 211. Readers 213 produce a digital or analog signal, depending on the particular application. In some applications the decoded signal from an audio reader 213 can be used “as-is” if it is output in a suitable analog format. In other applications, however, the output signal from a reader 213 comprises digital data that must be futther processed. The output signal from a reader 213 may include information, such as surround sound information, that can be used to provide enhanced audio performance. In many cases this additional information may use a proprietary format communicate the enhanced information such as Dolby Digital, Dolby Pro Logic II, Dolby Digital EX, THX EX and Dolby SR formats defined by Dolby Laboratories, Inc. and/or DTS, DTS Neo:6, DTS ES, and DTS 96/24 formats defined Digital Theatre Systems, as well as other formats that are or may become available. In these applications a digital sound processor 215 may be used to process the audio signal from readers 213 to perform such actions as decoding the digital signal, apply filters, equalize, and/or otherwise process the audio signal.

Intelligent audio switch 101 is preferably configured such that primary input 103 is active when there is an error, power failure, or other interruption in normal operation of intelligent audio switch 101. In a typical environment only one primary multi-channel signal is generated at any time, hence, it may not be necessary to provide multiple primary inputs 203 for each primary audio source.

Readers 213 output analog and/or digital audio signals to an appropriate one of digital sound processors 215. Each audio format that is being processed may require a unique sound processor 215. For example, a Dolby format audio signal is proprietary and must be decoded and processed by a Dolby sound processor 213 such as a DA-20 digital adapter/sound processor from Dolby Laboratories. On the other hand, for DTS format audio signals a DTS-6D digital playback system may be used for sound processor 213. The DTS-6D receives reads timecode information on the film-based media and plays audio from a separate device such as a CDROM in synchronization with the film-based media.

In a particular implementation of the present invention a first sound processor 213 comprises a Dolby format processor and a second sound processor 213 comprises a DTS format processor. Intelligent audio switch 201 is provided with two multi-channel analog audio input ports for connection to alternative digital sound processors 213, however, only one of the processors 213 is coupled to a primary multi-channel analog audio input 103. In the specific implementation only one primary input 203 is provided so that either the Dolby format processor or the DTS format processor can be coupled so as to pass through to output 207 in the event of a malfunction or power down condition.

As in the implementation of FIG. 1, any number of alternative analog audio sources 220 can be coupled to multi-channel analog audio inputs 205, limited only by the number of multi-channel analog audio inputs 205 provided on intelligent audio switch 201. Any number of alternative digital audio sources 220 can be coupled using a digital media adapter 117 such as a DMA-8 digital media adapter from Dolby Laboratories, limited only by the number of digital provided by the digital media adapter 117.

Like the embodiment of FIG. 1, a cinema client computer 123 can be coupled to an input 205 of intelligent audio switch 201 to provide a multi channel audio signal that may associated with a digital media presentation. Cinema client 123 implements programs for coordinating the various devices that present information in an auditorium or group of auditoriums. Cinema client 123 may also implement control connections (not shown) to various other devices such as lighting systems, cinema automation systems, projectors 111/121, and other systems to control multiple aspects of an event presentation. In the particular implementations described herein, intelligent audio switch 201 is controlled by theatre automation equipment including devices such as CA21, CA100, and Christie 3Q automation equipment, available from Christie Digital Systems, Inc., that can be programmed to perform desired functions in response to receiving cue signals.

In addition to providing control information to various controlled devices, cinema client 123 may receive status information from the various controlled systems including status messages from intelligent audio switch 201. The status information may be provided periodically by intelligent audio switch 201, or may be provided in response to status inquiries initiated by cinema client 123 and communicated in the control messages. The ability to obtain and manage status information is a significant advantage in automating the theatre environment that has not been available in prior audio switching devices. The command and status information can be communicated with intelligent audio switch 201 (or 101 in FIG. 1) using a shared serial port such as an RS-232 port. The present invention contemplates a command/response message protocol implemented on this connection to implement the control and status messaging.

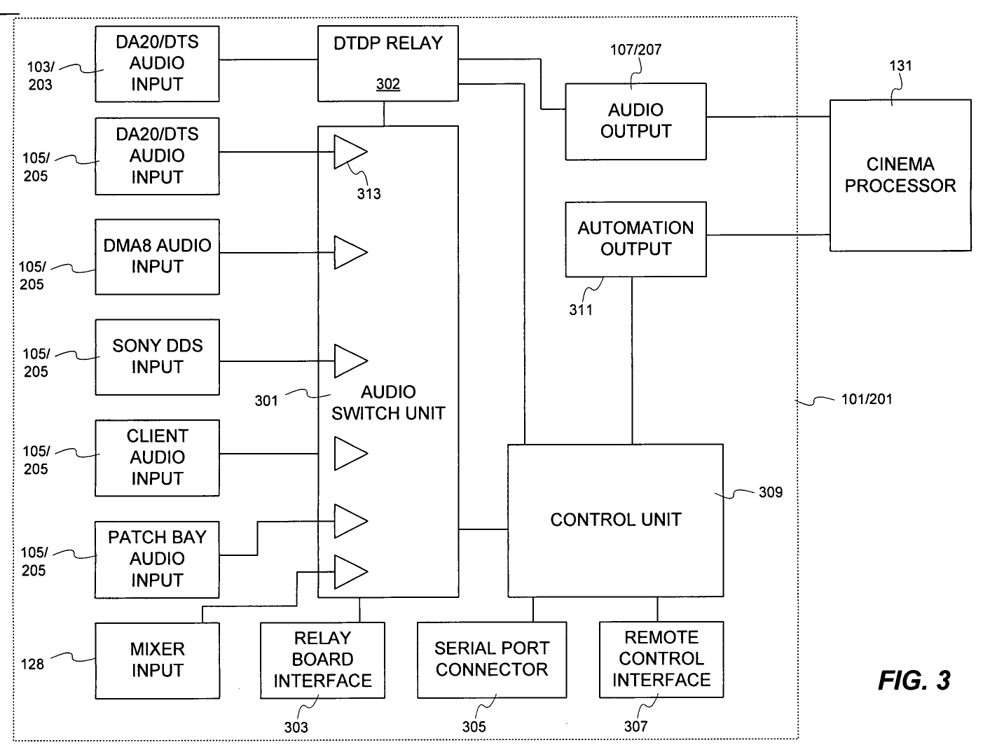

FIG. 3 shows, in block-diagram form, an intelligent audio switch in accordance with an embodiment of the present invention. In the particular implementation of FIG. 3 primary multi-channel analog audio inputs 103/203 are switched by a DPDT relay(s) 302. One relay channel is provided for each channel of a multi-channel signal being switched. For example, a 5.1 audio signal requires at least six relay channels. Although relays are available with multiple inputs, it is contemplated that one may use multiple relays instead to implement the necessary channel switching capacity. Specifically, six input channels can be switched using a single six-input relay 302, or a combination of three two-input relays 302 that are controlled by a common control signal from control unit 309. Control unit 309 comprises, for example, theatre automation equipment including devices such as CA21, CA100, and Christie 3Q automation equipment, available from Christie Digital Systems, Inc. The configuration chosen for a given application is selected to meet cost, performance and reliability requirements of an application.

Relay 302 comprises one set of signal inputs coupled to a primary multi-channel analog audio input 105/205, and a second set of signal inputs coupled to the output of audio switch matrix 301. The control signal from control unit 309 selects one or the other of these input and couples the selected input to multi-channel analog audio output 107/207. Relay 302 is configured such that when power is off the relay(s) 302 default to connect primary audio input 103/203 to the audio output 107/207.

Multi-channel analog audio inputs 105/205 are implemented using, for example, integrated audio switch circuits. Although switch matrix 301 could also be implemented with relays, in the particular implementation switch matrix 301 may be implemented using one or more audio switch integrated circuits that provide cost and size advantages. Suitable integrated circuits are available from a variety of semiconductor device vendors. Some or all of inputs 105/205 may include level adjustment components 313 that implement a gain level under control of control unit 309. In this manner volume can be adjusted on a per-channel basis (i.e., each channel of a multi-channel input controlled independently) or on a per-input basis. Level adjustment components 313 may be integrated with the switching integrated circuits or provided in separate devices. It is contemplated that integrated audio switch circuits may be eliminated by using the level adjustment components 313 only to selectively amplify or mute selected inputs 105/205.

Control unit 309 comprises a microcontroller or similar integrated circuit controller that receives commands from client 123 via serial port connector 305 and/or a remote control interface 307. Control unit 309 generates control commands to audio switch unit 301 and relays 302, as well as providing status messages on serial port connector 305. Control unit 309 may also generate automation messages to cinema processor 131 via an automation output 311.

Although the invention has been described and illustrated with a certain degree of particularity, it is understood that the present disclosure has been made only by way of example, and that numerous changes in the combination and arrangement of parts can be resorted to by those skilled in the art without departing from the spirit and scope of the invention, as hereinafter claimed.

We claim:

1. An audio switch comprising:
a plurality of analog audio inputs;
an audio output;
a control interface configured to couple to an external control system; and
means for selectively coupling any one of the audio inputs to the audio output in response to control signals received over the control interface.

2. The audio switch of claim 1 wherein at least some of the analog audio inputs comprise multi-channel analog audio inputs.

3. The audio switch of claim 2 wherein the analog audio inputs comprise 5.1 audio inputs.

4. The audio switch of claim 2 wherein the analog audio inputs comprise 6.1 audio inputs.

5. The audio switch of claim 1 wherein the means for selectively coupling further comprises:
a relay coupled to a selected one of the audio inputs and coupled to the audio output, wherein the relay has an un-powered state in which the selected audio input is coupled by the relay to the audio output and the remaining audio inputs are decoupled from the audio output.

6. The audio switch of claim 1 further comprising a pre-amplifier component coupled to at least one of the audio inputs.

7. The audio switch of claim 6 wherein the pre-amplifier is externally controllable to provide a level of pre-amplification determined by an external control signal.

8. The audio switch of claim 6 further comprising an audio balancing component coupled to at least one of the audio inputs and operable to eliminate hum caused by inadequate grounding

9. The audio switch of claim 1 further comprising a pre-amplifier component coupled to between an output side of the relay and the audio output.

10. The audio switch of claim 9 wherein the pre-amplifier is externally controllable to provide a level of pre-amplification determined by an external control signal.

11. The audio switch of claim 1 wherein the means for selectively coupling is externally controllable to allow an external control component to couple a selected one of the plurality of audio inputs to the audio output.

12. The audio switch of claim 1 further comprising an audio mixer component coupled to the means for selectively coupling, wherein the audio mixer components is configured to couple to an external local audio source.

13. The audio switch of claim 12 wherein the external local audio source comprises a microphone.

14. The audio switch of claim 12 wherein the external local audio source comprises a DVD player.

15. A cinema audio system comprising:
a projector operable to display media in a theatre auditorium;
a sound processor operable to generate a multi-channel analog audio signal synchronized with the displayed media;
at least one other device producing a multi-channel analog audio signal;
a switch having a plurality of analog audio inputs, wherein a first of the plurality of analog inputs is coupled to the sound processor to receive the multi-channel analog audio signal of the sound processor, and a second of the plurality of analog inputs is coupled to the at least one other device, wherein the switch comprises an audio output; and
means for selectively coupling any one of the plurality of the switch's audio inputs to the audio output.

16. The cinema audio system of claim 15 further comprising a back-end cinema audio system driving speakers in the theatre auditorium, wherein the back-end cinema audio system comprises fewer multi-channel analog audio signal inputs than are provided by the switch and the audio output of the switch is coupled to one of the multi-channel analog audio signal inputs of the back-end cinema audio system.

17. The cinema audio system of claim 15 wherein the projector comprises a film projector operable to display film-based media and the sound processor comprises:
a reader coupled to read audio information encoded on the film-based media;
a decoder coupled to the reader and operable to decode the audio information and generate a multi-channel analog audio signal.

18. The cinema audio system of claim 15 wherein the projector comprises a film projector operable to display film-based media and wherein the sound processor comprises:
a player coupled to read audio information from a media source separate from the film-based media;
a synchronization component coupled to the player and to the film projector and operable to synchronize the audio information with the display of the film-based media.

19. The cinema audio system of claim 16 wherein the at least one other device comprises a digital media adapter comprising a plurality of digital audio signal inputs.

20. The cinema audio system of claim 16 wherein the at least one other device comprises a microphone.

21. The cinema audio system of claim 16 wherein the at least one other device comprises a computer playing a multimedia file.

22. The cinema audio system of claim 15 wherein the projector comprises a digital cinema projector.
